(19) United States
(12) Patent Application Publication
(10) Pub. No.: US 2015/0212220 A1
(43) Pub. Date: Jul. 30, 2015

(54) ACOUSTIC PISTON TRACK

(71) Applicant: Sensorlink AS, Trondheim (NO)

(72) Inventor: Øystein Baltzersen, Trondheim (NO)

(73) Assignee: Sensorlink AS, Trondheim (NO)

(21) Appl. No.: 14/424,264

(22) PCT Filed: Aug. 27, 2013
(86) PCT No.: PCT/EP2013/067677

§ 371 Date: Feb. 26, 2015

(30) Foreign Application Priority Data
Aug. 28, 2012 (NO) 20120965

(51) Int. Cl. G01V 1/00; G01D 5/12

(52) U.S. Cl. CPC G01V 1/00; G01D 5/12; G01N 2291/045

(57) ABSTRACT

Method and device for determining the position of a piston in a cylinder comprising use of both ultrasound transducer and magnetometer for transmitting and receiving signals that are interpreted in a signal processor for determining the position of the piston.

The present invention comprises a method and device for determining the position of a piston in a cylinder. More specifically the invention comprises a flexible method and device for accurate determining the position of a piston in a cylinder without invading the cylinder.

### BACKGROUND

Uses of a non-invasive method for measuring different parameters as for instance level/position of contents in tanks and cylinders are known.

US-20090282910 describes a non-invasive method for measuring the degree of filling in a tank by means of an acoustic measuring principle. The measuring principle is to generate vibrations in a tank by means of an external source and to determine the degree of filling based on vibration as a function of applied frequency. Acoustic transducers function as accelerometers for measuring degree of vibration. The method described is however not well suited for determining the position to a piston with great accuracy.

DE-102005005965 describes a device for detection of the position of a piston by means of ultrasound. The device has an ultrasound sensor connected on the outside of the cylinder for transmission of ultrasound pulses and electronics for interpreting of signals propagating through the pipe wall of the cylinder and fluid in the cylinder.

Ultrasound pulses are reflected from the opposite pipe wall. In cases where the pipe/cylinder is filled with gas, liquid with air bubbles or a piston, an echo will be degraded or disappear due to large attenuation of the signal. Use of such a method for detecting the position of a cylinder in a pipe is thus in many cases not suited due to weak signals and false detections.

There are different types of vertical movement compensators for disengaging a drilling string from the vertical movement of a drilling rig. Such systems comprise a piston in a cylinder, and in specific operations it is important to know the precise piston position. It has turned out that a precise determination of the position of a piston is difficult due to continuous changes in the composition of gas and fluid above and below the piston when this is moving.

It is thus a need for a reliable method and device for accurate and continuous determination of piston position independently of the composition of fluid above and below a piston.

The present invention achieves this by combining transmission and detection of acoustic pulses with detection of changes in magnetic field.

The invention is a method and device for determining the position of a piston in a cylinder, where the cylinder on one side of the piston is filled with fluid and on the other side it can be filled with gas.

As mentioned, knowing the exact position of a piston in a cylinder is important for instance for surveying hydraulic accumulators for heave compensation of floating drilling rigs, where reliable knowledge of the piston position can increase the drilling security.

The system of the present invention is modular and can be mounted on a cylinder without opening this or disturbing drifting. The system is further suited for use in areas with a danger of explosion.

### SHORT DESCRIPTION

The invention is defined by a method for determining the position of a piston in a cylinder, and where this is performed by placing at least one ultrasound transducer and at least one magnetometer in even distance along the longitudinal direction and on the outer wall of the cylinder wall, and transmitting and receiving signals from respective transducers. The position of the piston is determining in a signal processor by interpreting reflected acoustic signals and changes in magnetic field, where reflected acoustic signals are interpreted by combining measured time delays and amplitudes of these signals.

Further features of the invention are defined in the claims.

The invention is also defined by a system for determining the position of a piston in a cylinder, where the system comprise at least one ultrasound transducer and at least one magnetometer placed in even distance along the longitudinal direction and on the outer wall of the cylinder wall. The system further comprises a controller connected to the ultrasound transducer(s) and magnetometer(s) comprising means for sending and receiving signals from respective transducers. The system further comprises signal processing means for measuring and interpreting time delays and amplitudes of reflected acoustic signals and changes in magnetic field for determining the position of the piston as well as a display unit for displaying the position of the piston.

Further features of the system are defined in the claims.

### DETAILED DESCRIPTION

The invention will now be described in detail with reference to the figures where:

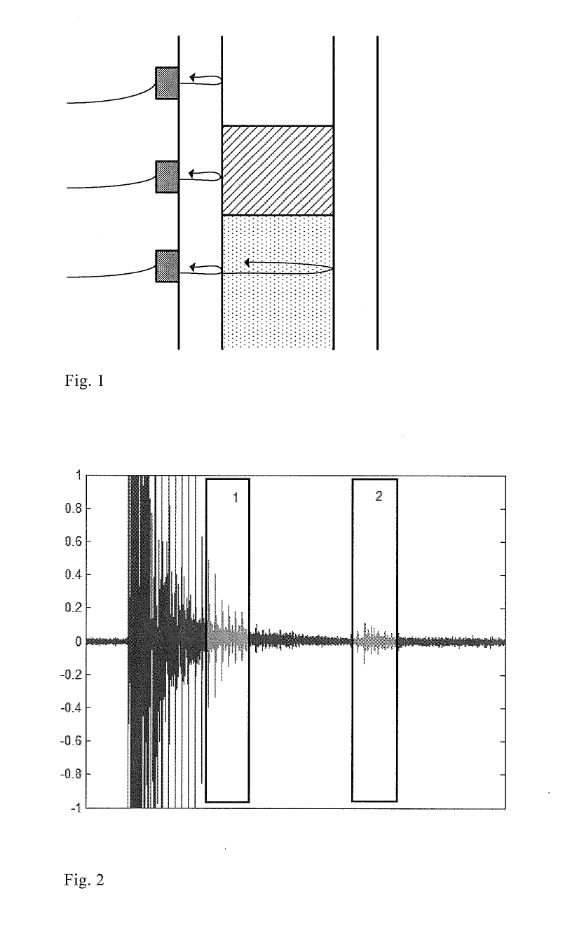

FIG. 1 shows a hydraulic cylinder with transducers placed on the outside;

FIG. 2 shows ultrasound signal from a transducer mounted on a pipe filled with fluid;

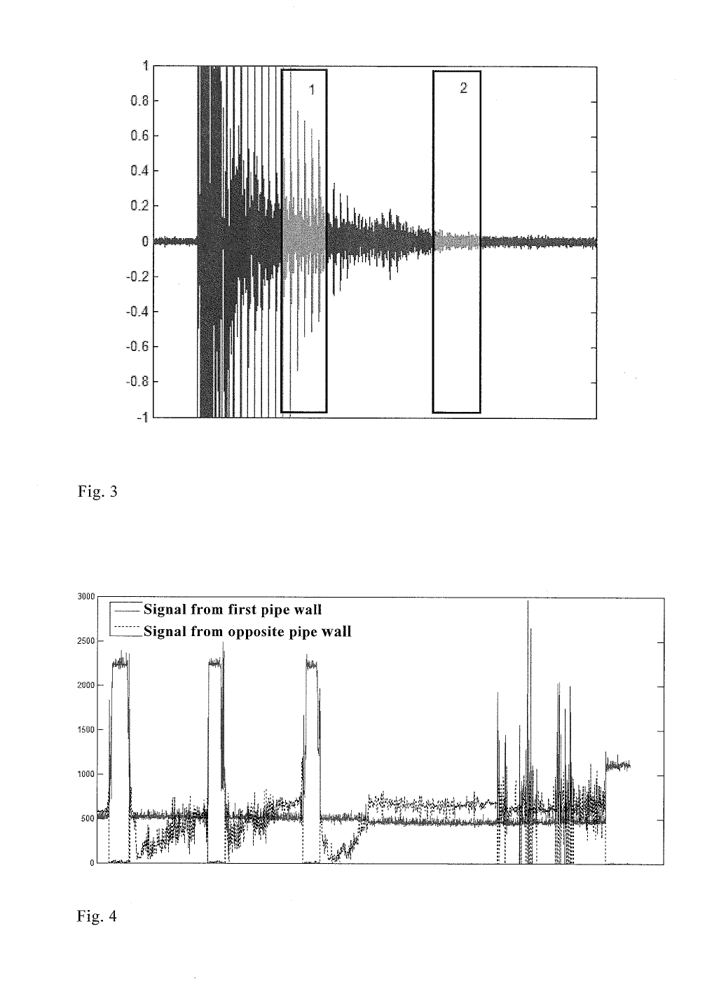

FIG. 3 shows ultrasound signal from a transducer mounted on a pipe filled with fluid;

FIG. 4 shows signal from an ultrasound transducer in a system for piston detection, and

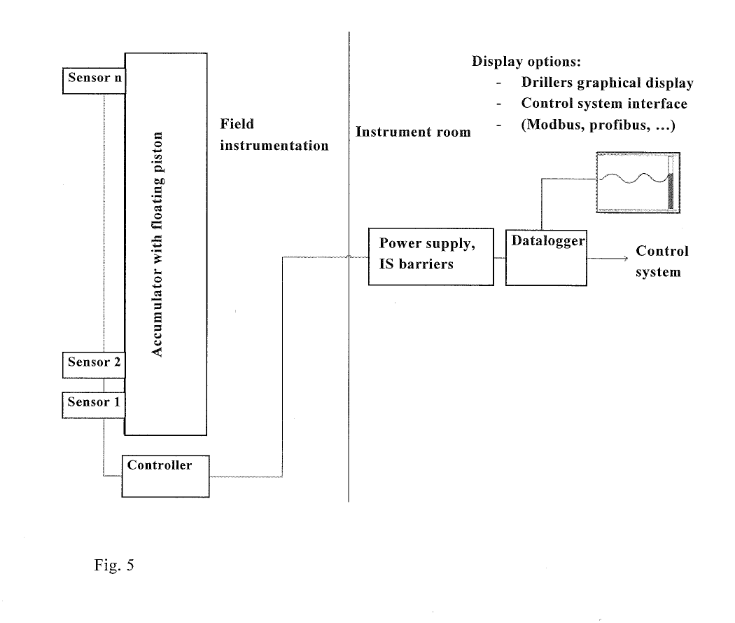

FIG. 5 shows a typical installation with a complete measuring system.

As mentioned there is a need for a method and device for accurate and continuous determination of piston position independently of the fluid composition above and below a piston.

The present invention achieves this by combining transmission and detection of acoustic pulses with detection of magnetic field.

The invention presents a method and apparatus for accurate determination of the position of a piston in a cylinder, where the cylinder on one side of the piston is filled with fluid and with gas on the other side.

The invention can be used in different setups and accurate position can be found independently of gas/liquid composition above and below a piston, thickness of the pipe wall in which the cylinder is running in or changes in the magnetic field of the surroundings.

A known principle when using ultrasound used in the present invention is that a surface between steel and gas will reflect a larger portion of an ultrasound pulse than a surface between steel and liquid, since gas has very low acoustic impedance. The reflection coefficient Rₚ for a junction between two materials with acoustic impedance Z₁ and Z₂ is given as:

$${R}_{p} = {( \frac{{z}_{2} - {z}_{1}}{{z}_{1} + {z}_{2}} )}^{2}$$

As an example, the junction between steel and air will give a reflection coefficient of approximately Rₚ=1 since all energy in the pulse is reflected, while a junction between steel and water will give Rₚ=0.88. This can be used for proving if there is fluid or gas in a pipe, and thus for determining the position of a piston dividing gas and fluid in a cylinder.

FIG. 1 shows such a measuring system. The figure shows a hydraulic cylinder with fluid below the cylinder and gas above the cylinder. Ultrasound transducers are mounted on the underside of the pipe wall of the cylinder. The figure illustrates different reflections of sound waves. As explained above, an ultrasound pulse will not be transferred from the steel wall to the gas. The upper most transducer captures reflections from the inside of the pipe wall. The middle transducer captures reflections from the pipe wall/piston, while the lowest transducer captures weaker reflections from the pipe wall and time delayed reflections from the opposite side of the pipe.

FIG. 2 is an example of an ultrasound signal from a pipe with fluid behind the pipe wall as shown in FIG. 1. The figure shows a signal corresponding to that produced by the lowest transducer in FIG. 1. Echoes from opposite pipe wall can be observed.

FIG. 3 shows an example of an ultrasound signal from a pipe with gas behind the pipe wall. The figure shows a signal corresponding to that the two upper transducers in the FIG. 1 will produce. In this figure echoes from the opposite wall are absent, but the amplitudes of the echoes from the first pipe wall are stronger than in FIG. 2.

By defining two measuring windows 1 and 2 (shown in FIGS. 2 and 3) two values can be defined as the sum of the rectified ultrasound signal over the two respective windows. These values can then be used for determining if there is gas or liquid behind the pipe wall. By putting this information from a plurality of transducers along the cylinder together, the position of the piston can be determined.

FIG. 4 shows an example of signals from a transducer while a piston is moving by. Solid-drawn line shows quantity of energy (arbitrary unit) reflected from the back of the first pipe wall, while dotted curve shows quantity of energy reflected from opposite pipe wall. Solid-drawn line shows a strong signal when there is gas in the tube (piston is below or by the transducer), and a weak signal when there is liquid in the tube (piston above the transducer). For the signal from the opposite wall it will be the other way around. When there is high movement velocity of the piston, fast changes in the composition of gas/liquid above and below the piston will result in that the acoustic signal from opposite wall will be disturbed by bobbles in the liquid.

The main aspect of the invention is as mentioned combining use of ultrasound with detection of changes in magnetic field. With large piston movements the signals indicating changes in magnetic field will be clear, while reflected acoustic signals can be unclear and difficult to interpret due to large attenuation of signals.

A magnetometer is a measuring instrument measuring characteristics of a magnetic field, e.g. changes in direction and power of the magnetic field. Used in the present invention, a magnetometer can measure the component of a magnetic field parallel to the cylinder axis (1-axis), or it can measure all three components in a magnetic field (3-axis). Which is chosen in a system setup will depend on type of requirement, pipe thickness etc. The invention is flexible in that it is modular and required number and type of sensors can be fastened on appropriate locations on the outside of the cylinder pipe of a piston. How the sensors are fastened is assumed as obvious for a skilled person. In a flexible set-up they are typically fastened and connected to the pipe wall by using clamps, strips or tightening bands.

The method according to the invention is about determining the position of a piston in a cylinder and comprises several steps.

The first step is placing at least one ultrasound transducer and at least one magnetometer in even distance along the longitudinal direction and on the outer wall of the cylinder wall.

In one embodiment each ultrasound transducer and each magnetometer is placed together as a pair in even distance along the longitudinal direction and on the outer wall of the cylinder wall. In another embodiment each ultrasound transducer and each magnetometer is placed individually in even distance along the longitudinal direction. Configuration and set-up of transducers is modular and can be configured according to requirements. When it for instance is required with a higher measuring resolution of position data transducers can be placed closer together along the longitudinal direction on the outer wall of the cylinder wall.

The next method step is transmitting and receiving signals from respective transducers.

In one embodiment transmitted signals from ultrasound transducers are acoustic pulses which above and below a piston will be reflected from the backside of the first pipe wall from opposite pipe wall. Reflected signals are interpreted by signal processing means in that this combines measured time delays and amplitudes of signals from several transducers.

When a piston pass an acoustic transducer the shape of received acoustic signals will be affected. As seen from the different signal curves in FIGS. 2 and 3, the amplitude of the signal reflected from the backside of the first pipe wall is larger when gas or a piston is in the signal path of the acoustic propagation signal. This information is further utilized when interpreting received signals.

In a preferred embodiment of the invention, a plurality of acoustic transducers is used. These are places along the longitudinal direction and on the outside of the cylinder of the piston. By interpreting and comparing amplitudes and time delays of received acoustic signals from a plurality of transducers information of time progress for the position of a piston can be obtained, i.e. position as a function of time.

As mentioned acoustic measurements can be disturbed and attenuated by liquid with large gas cut which typically happens with big piston movements. According to the invention inaccurate measurements or loss of measurements are avoided (due to weak signal or signal drowning in noise) with use of one or more magnetometers in addition to acoustic transducers.

When a piston is passing a magnetometer the magnetic field measured will change. In order to achieve larger changes in measured magnetic field caused by a piston, the piston can be magnetized or it can be a magnet connected to the piston.

The last step of the inventive method is interpreting reflected acoustic signals as explained above as well as interpreting changes in magnetic field.

The last mentioned is performed by looking for changes in the magnetic field measured by several sensors placed along the cylinder. The position of a moving piston can then be determined without being disturbed by changes in magnetic filed from the surroundings (e.g. due to changing orientation of geomagnetic filed, or from magnetized object). For a cylinder with thick steel walls the contribution from the piston to the magnetic field on the outside of the cylinder can be small compared to the contribution from the surroundings. Positioning with only magnetometer can thus alone function poorly with small or none piston movement.

The interpretation of signals is performed with the use of a signal processor for determining the position of the piston.

The signal processor can be located locally where the transducers are placed, or it can be placed at a remote location where it receives measuring signals via wireless transmitting means connected to the transducers.

By combining interpretation of signals from ultrasound transducers and magnetometers the piston position can be determined with great accuracy at any time and under different operating conditions. The two measuring methods complement each other. The ultrasound signals produce the most reliable detection of the piston with small or none movement since bubbles or turbulence will not exist in the liquid. The magnetometer measurements will produce the most reliable detection with large piston movement giving fast changes of magnetic field from the piston that easily can be separated from magnetic field of the surroundings. A detected change of the magnetic filed is totally independent of bubbles or turbulence in the liquid above or below a piston.

As mentioned, reflected acoustic signals from opposite pipe wall will be degraded due to big piston movements. In one embodiment of the invention, when detecting large piston movements, interpretation of reflected acoustic signals will go from interpreting acoustic signals reflected from the opposite pipe wall to interpreting acoustic signals reflected from the first pipe wall. This will contribute to increased accuracy.

The invention is also defined by a system for determining the position of a piston in a cylinder.

FIG. 5 shows a typical set-up of a system comprising at least one ultrasound transducer and at least one magnetometer placed in even distance along the longitudinal direction and on the outer wall of the cylinder wall. The figure shows a plurality of ultrasound transducers and magnetometers marked as Sensor 1 to n. The sensors are further connected to a controller.

A controller can also in an alternative embodiment of the system be included in each sensor. Sending of analogue signals through long cables is then avoided. Signals from each controller are digital and thus less exposed to noise.

As mentioned the different sensors can be placed as pair or separately. As such Sensor 1 can comprise one ultrasound transducer and one magnetometer. Alternatively Sensor 1 can be an ultrasound transducer while Sensor 2 can be a magnetometer. Different configurations of individually sensor and/or sensor in pairs are possible according to the requirement.

The primary task of the controller is to send and receive analogue and digital signals to/from the sensors. The controller can however comprise means for digitizing and sending signals wirelessly to a remote located signal processor.

The controller receives signals from the different sensors comprised in the system. The controller can comprise a signal processor for processing data and it can via transmitting means transmit processed information regarding piston position. Alternatively the controller can coordinate received analogue signals from the different sensors, digitize these and transmit the signals to a remote unit for further processing. In such a set-up the system comprises communication means for communicating signals to and from a remote unit.

The controller can further in one embodiment of the system be remote operated in that it receives information regarding which signals that at any time should be transmitted to Sensor 1 to n, i.e. which ultrasound signals to transmit. Such option increases the flexibility of the system with regards to adaption to where and what to measure.

The system can also comprise several units placed in an instrument room. It can be powered by a power supply with IS (Intrinsic Safety) barrier and which is connected to a data logger for logging and storing the history of position data for the piston as well as displaying means for displaying the position of the piston. The data logger can be connected to displaying means, where an end user of the system is presented for different information as real time data of the position of a piston, history for position etc.

The data logger can also be connected to a control system that based on the piston position transmit instructions for executing necessary actions as for instance warning that the piston position is outside a preset interval.

By combining transmission and detection of acoustic pulses with detection of changes in magnetic field, as is the case in the present invention, a reliable and flexible method and device for accurate determining of piston position is achieved, and where this is independent of continuous changes in the composition of liquid above and below a piston.

The present invention will give accurate and reliable information regarding position of a piston in a cylinder during different operations where a piston in a cylinder is comprised as in for instance vertical movement compensators on drilling rigs where maximum focus on security is important.

1. Method for determining position of a piston in a cylinder, characterized in:
placing at least one ultrasound transducer and at least one magnetometer in even distance along the longitudinal direction and on the outer wall of the cylinder wall;
transmitting and receiving signals from respective transducers;
determining in a signal processor the position of the piston by interpreting reflected acoustic signals and changes in magnetic field, where reflected acoustic signals are interpreted by combining measured time delays and amplitudes of these signals.

2. Method according to claim 1, characterized in that each ultrasound transducer and each magnetometer is placed together as a pair in even distance along the longitudinal direction and on the outer wall of the cylinder wall.

3. Method according to claim 1, characterized in that each ultrasound transducer and each magnetometer is placed individually in even distance along the longitudinal direction.

4. Method according to claim 1, characterized in that transmitted signals from ultrasound transducers are acoustic pulses.

5. Method according to claim 1, characterized in that the piston is magnetized in that it comprises a magnet.

6. Method according to claim 1, characterized in that interpreting of acoustic signals reflected from the pipe wall of the cylinder where the transducers are mounted are combined with interpreting of acoustic signals reflected from the opposite pipe wall.

7. Method according to claim 1, characterized in that only interpretation of acoustic signals reflected from the pipe wall of the cylinder where the transducers are mounted is performed when large piston movements are detected.

8. System for determining position of a piston in a cylinder, characterized in that it comprises:
at least one ultrasound transducer and at least one magnetometer placed in even distance along the longitudinal direction and on the outer wall of the cylinder wall;
a controller connected to the ultrasound transducer(s) and magnetometer(s) comprising means for sending and receiving signals from respective transducers;
signal processing means for measuring and interpreting time delays and amplitudes of reflected acoustic signals and changes in magnetic field for determining the position of the piston, and
display unit for displaying the position of the piston.

9. System according to claim 8, characterized in that said controller is integrated in each transducer and each magnetometer.

10. System according to claim 8, characterized in that the system further comprises a data logger for logging position data of the piston.

11. System according to claim 8, characterized in that the system further comprises wireless communication means for communicating signals to and from a remote unit.
